(19) United States
(12) Patent Application Publication
(10) Pub. No.: US 2009/0020224 A1
(43) Pub. Date: Jan. 22, 2009

(54) HEAT SEALABLE COMPOSITE WRAP MATERIAL

(76) Inventors: Michael R. Nowak, Hilbert, WI (US); Lou Ann Mueller, Little Chute, WI (US); William R. Arndt, Hilbert, WI (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/755,345

(22) Filed: May 30, 2007

Related U.S. Application Data
(62) Division of application No. 10/385,117, filed on Mar. 10, 2003, now abandoned.
Application No. 10/385,117 is a continuation-in-part of application No. 09/178,329, filed on Oct. 23, 1998.

(51) Int. Cl. B32B 37/12

(52) U.S. Cl. 156/280

(57) ABSTRACT

Composite wrap materials for use as a protective covering in a variety of applications, and methods of making the composite wrap materials. More particularly, the invention relates to composite wrap materials used for packaging paper products.

### RELATED APPLICATIONS

The present application is a divisional of Ser. No. 10/385,117, filed Mar. 10, 2003, which is a continuation in part of Ser. No. 09/178,329, filed Oct. 23, 1998, now pending, and 10/094,060, now pending.

### FIELD OF THE INVENTION

The present invention relates to composite wrap materials for use as a protective covering in a variety of applications, and methods of making the composite wrap materials. More particularly, the invention relates to composite wrap materials used for packaging paper products.

### BACKGROUND OF THE INVENTION

Reams of paper for copy machines, computers, and other applications, are found in retail stores packaged in various composite or non-composite wrap materials. In addition to keeping the paper contained in the package, the wrap provides a moisture barrier that prevents or delays the absorption of moisture by the wrapped paper. The wrap also presents the paper contained inside in an eye appealing manner to the consumer.

Conventional commercial wrappers include paper/polyethylene/paper laminates, paper/wax/paper laminates, polyethylene-coated papers, wax-coated papers, and transparent polymer films. A drawback of paper-based wrap materials is their low burst strength. Oftentimes, such packages tend to break open before reaching the consumer because the wrapper is not strong enough to hold the paper upon repeated handling and stacking on store shelves. This not only ruins the product by causing an unsightly appearance on a store shelf, but can damage the paper which can cause copiers and printers to become jammed.

A disadvantage of film-based wrap materials that do not contain paper is that they are difficult to run on conventional packaging equipment during the wrapping process and require costly modifications to a paper packaging line.

In addition, film-based wrap materials have a low burst strength, and lack the structural support of the heavier paper structures.

Another disadvantage of known wraps is that they process either like paper or film, depending on their major component. While providing a good dimensionally stable print surface, paper does not provide the gloss or the ink holdout of film structures. Film, while providing gloss and ink holdout, is more flexible and much more difficult to handle than paper due to its stretch properties.

As store distribution of such paper products has increased, paper companies have wanted to improve the graphics on the packaging for greater shelf appeal, and increase the strength of the wrapper to dependably contain a ream of paper until opened by the consumer.

U.S. Pat. No. 3,616,191 relates to a method of obtaining improved adhesion of extruded olefin polymer coating materials to packaging material substrate, involving the use of a hydrolyzed copolymer of an olefin and ester of an unsaturated alcohol, as an adhesion improving primer or tie coat. This patent relates to a polyolefin coating on a paper with a primer in between. A sheet of paper with a poly coating applied at a high temperature as a liquid is applied and then cooled to solidify on the paper. A coating to promote adhesion of the poly to the paper is applied to the paper before the poly is applied. The poly becomes an integral part of the paper that is observable on the glossy side, but the coating to promote adhesion is not observable as it is buried between the poly and the paper.

U.S. Pat. No. 6,150,035 relates to a composite laminate for preparing labels. The composite laminate comprises a substrate sheet of paper, a first coating of polyolefin film having a printable upper surface and a lower surface bonded to the upper surface of the substrate sheet. A second coating of polyolefin film has its upper surface bonded to the lower surface of the substrate sheet. A third coating comprising a pressure-sensitive adhesive is placed on the lower surface of the second coating of polyolefin film. These composites may be used as the face of other composites such as labels, tapes, etc.

U.S. Pat. No. 4,196,247 relates to a flexible heat sealable packaging material including a flexible web of substrate material, a normally tacky heat sealable wax composition on the surface of the substrate and a non-blocking coating applied as a hot melt over the heat sealable layer. The non-blocking coating melts at the heat sealing temperatures to allow the underlying heat sealable material to pass therethrough and complete the seal.

U.S. Pat. No. 5,837,383 relates to recyclable and compostable paper stock comprising a substrate coated on at least one surface with a primer coat and a top coat both of which are water based dispersions. The substrate is coated with a primer coat prior to the application of the top coat to seal the substrate surface.

U.S. Pat. No. 5,989,724 relates to recyclable and repulpable coated paper stock, preferably for use as a ream wrap, comprising a substrate coated on at least one surface with a base coat and at least one additional coat over the base coat. The wax free coating forms a pin-hole free continuous film on the substrate.

Therefore, an object of the present invention is to provide a composite wrap material that can be used to wrap a ream of paper or other material to provide a wrapped package having high burst strength. Burst strength is determined by standardized tests such as that defined by the American Society for Testing and Materials test ASTM D 774, entitled “Test Method for Bursting Strength of Paper.” This test can also be used to determine the burst strength of polymer materials such as polyethylene terephthalate film and sheeting (ASTM D 5047-95). A high burst strength means that by testing an appropriate sample of available ream wrap products having the same basis weight according to a standardized test such as ASTM D 774, the wrap made has a higher burst strength.

Another object is to provide a composite wrap material that will provide a barrier against moisture absorption by the wrapped contents. Water vapor transfer rate (WVTR) as determined by a standardized test method such as TAPPI T464 om-90 for a product made in accordance with the claimed invention is less than 0.5 g/100 in2/24 hr at 100 degrees Fahrenheit, 90% relative humidity.

Another object is to provide a composite wrap material having the fold characteristics of paper. Fold characteristics relate to when a crease is put into a material, it stays there. The material does not have a memory causing the fold to open, as with the case with film.

Yet another object is to provide a composite wrap material that can have a high gloss print surface or a standard paper print surface as desired. A farther object is to provide a composite wrap material that can be provided in various forms according to different applications.

### SUMMARY OF THE INVENTION

These and other objects and advantages are achieved in the present composite wrap material, a process of making the wrap material, and use of the wrap material to package paper and other materials.

The present invention relates to a composite wrap material comprising a layer or sheet of a paper or cellulosic material and a layer of a polymer film material that are integrally bonded together by means of an adhesive layer interposed thereinbetween. The polymer film layer and/or the adhesive layer function to provide a moisture vapor barrier to protect the contents packaged within the wrap material.

The wrap material can provide a clear or transparent wrap such that a consumer can see the paper layer laminated to the polymer film layer. One or more layers can optionally contain a pigment to provide coloration. The wrap can also be provided with a high gloss print surface or a standard paper print surface. In another variation, the paper material and/or the polymer film can be a metalized material. In addition, the paper material can be printed before lamination so that the print shows through the film layer.

The composite paper/film wrap material can be prepared by laminating a three-layer structure composed of the layer of paper, the adhesive layer, and the polymer film layer, using a nip roller apparatus or other suitable laminating device. The paper and polymer film layers with the adhesive layer thereinbetween can be passed through a pair of nip rollers to bond the two layers together. The processing temperature can be maintained to control the processing temperature of the adhesive material.

Advantageously, the resulting composite wrap facilitates high burst strength of the final package, the option of a high gloss print surface or a standard paper print surface, a moisture barrier to prevent moisture absorption by the wrapped paper, and the fold characteristics of paper.

It is an object of the present invention for the ream wrap to comprise a film-poly-paper as described above, having an additional layer of poly coated on the paper. The ream wrap comprises a film/poly/paper/poly configuration. This additional layer of poly can be either polyethylene or polypropylene. This allows the inner layer of poly to bond to the outer film layer through heat. This eliminates the need for gluing the product. There may be additional coatings or treatments, or other layers that can be added to the outside of the film to provide the heat seal.

It is an object of the present invention for the ream wrap to comprise a film-adhesive-paper, having an additional layer of poly coated on the paper. The ream wrap comprises a film/adhesive/paper/poly configuration. This layer of poly can be either polyethylene or polypropylene. This allows the adhesive layer to bond to the outer film layer through heat. This eliminates the need for gluing the product. There may be additional coatings or treatments, or other layers that can be added to the outside of the film to provide the heat seal.

The present invention relates to a composite wrap material for wrapping reams of paper comprising: a layer of paper, a heat seal layer, and a poly layer between the paper and the heat seal layer. It is an object of the present invention for the paper to have a basis weight of about 20-60 lbs/3,000 sq. ft. It is an object of the present invention for the layer of paper to comprise a material selected from the group consisting of machine finished paper, machine glazed paper, tissue, air laid fabric, wet laid fabric, creped tissue, and a metallized paper. It is an object of the present invention for one or more of the layers to be pigmented. It is an object of the present invention for the poly layer to be either polyethylene or polypropylene. It is an object of the present invention for the heat seal coating to be ethylene based.

The present invention relates to a composite wrap material for wrapping reams of paper comprising: a layer of paper, a poly layer on top of the paper layer, a primer layer on top of the poly layer, and a heat seal layer on top of the primer layer. It is an object of the present invention for the layer of paper to have a basis weight of about 20-60 lbs/3,000 sq. ft. It is an object of the present invention for the layer of paper to comprise a material selected from the group consisting of machine finished paper, machine glazed paper, tissue, air laid fabric, wet laid fabric, creped tissue, and a metallized paper. It is an object of the present invention for one or more of the layers to be pigmented. It is an object of the present invention for the poly layer to be either polyethylene or polypropylene. The primer layer is a layer of chemicals which promotes the heat seal layer to adhere. It is an object of the present invention for the heat seal layer to be ethylene based.

The present invention relates to a composite wrap material for wrapping reams of paper comprising: a first layer of paper, a second layer of film, a layer of adhesive or poly between the first layer and the second layer, a layer of primer on top of the film layer and a heat seal layer on top of the primer layer. It is an object of the present invention for the layer of paper to have a basis weight of about 20-60 lbs/3,000 sq. ft. It is an object of the present invention for the second layer to be a solid polymer film material. It is an object of the present invention for the second layer to be selected from the group consisting of polyethylene, polypropylene and polyester.

It is an object of the present invention for the first layer to comprise a material selected from the group consisting of machine finished paper, machine glazed paper, tissue, air laid fabric, wet laid fabric, creped tissue, and a metallized paper. It is an object of the present invention for the adhesive layer to comprise a polymer material selected from the group consisting of polyethylene, polypropylene, polyvinylidene chloride, polyethylene acrylic acid, polyester, polyisobutylene, nylon, polymethylpentene, and ethylene vinyl acetate, and copolymers thereof.

It is an object of the present invention for the adhesive layer to comprise a wax/polymer blend. It is an object of the present invention for the adhesive layer to comprise a hot-melt adhesive. It is an object of the present invention for one or more of the layers to be pigmented. It is an object of the present invention for a surface of the first or second layer to comprise a metallized material. It is an object of the present invention for the poly layer to comprises either polyethylene or polypropylene. It is an object of the present invention for the primer to comprise chemicals which promote the heat seal layer to adhere. It is an object of the present invention for the heat seal layer to be ethylene based.

The present invention relates to a composite wrap material for wrapping reams of paper comprising: a first layer of paper, a second layer of film, a layer of adhesive or poly between the first and second layers, and a heat seal layer on top of the second layer. It is an object of the present invention for the layer of paper to have a basis weight of about 20-60 lbs/3,000 sq. ft. It is an object of the present invention for the second layer to be a solid polymer film material. It is an object of the present invention for the second layer to be selected from the group consisting of polyethylene, polypropylene and polyester. It is an object of the present invention for the heat seal layer to be ethylene based.

It is an object of the present invention for the first layer to comprise a material selected from the group consisting of machine finished paper, machine glazed paper, tissue, air laid fabric, wet laid fabric, creped tissue, and a metallized paper. It is an object of the present invention for the adhesive layer to comprise a polymer material selected from the group consisting of polyethylene, polypropylene, polyvinylidene chloride, polyethylene acrylic acid, polyester, polyisobutylene, nylon, polymethylpentene, and ethylene vinyl acetate, and copolymers thereof.

It is an object of the present invention for the adhesive layer to comprise a wax/polymer blend. It is an object of the present invention for the adhesive layer to comprise a hot-melt adhesive. It is an object of the present invention for one or more of the layers to be pigmented. It is an object of the present invention for a surface of the first or second layer to comprise a metallized material. It is an object of the present invention for the poly layer to be either polyethylene or polypropylene.

It is an object of the present invention for the film layer to bond to said adhesive layer through the addition of heat. It is an object of the present invention for the paper layer and film layer to be integrally bonded together by the adhesive layer continuously. It is an object of the present invention for the wrap material to have less than about three air pockets in ten square feet of wrap material. It is an object of the present invention for the wrap material to retain a crease. It is an object of the present invention for the film layer to have a water vapor transmission rate measured at 90 percent humidity, 100 degrees Fahrenheit, g/100 in2/24 hours of less than 0.5.

The present invention relates to a method for producing a composite wrap material comprising; placing a paper layer and a film layer into an adjacent, non-contact position. An adhesive material is applied to the paper layer and/or the film layer. The layers are moved through nip rollers to form a composite wrap material. The composite wrap material is placed on a press and a heat seal coating is applied.

The present invention relates to a method for producing a composite wrap material comprising; placing a paper layer and a film layer into an adjacent, non-contact position. An adhesive material is applied to the paper layer and/or the film layer. The paper layer, film layer and adhesive material are passed through nip rollers, forming a composite wrap material. The composite wrap material is placed on a press and primer and heat seal coating are applied.

### BRIEF DESCRIPTION OF THE DRAWINGS

Throughout the following views, reference numerals will be used in the drawings, and the same reference numerals will be used throughout the several views and in the description to indicate same or like parts of the invention.

FIG. 1 is a cross-sectional view of a composite wrap material according to the invention.

FIG. 2 is a schematic view of an apparatus used to produce the composite wrap material of the present invention.

FIG. 3 is a cross-sectional view of a composite wrap material according to the invention.

FIG. 4 is a cross-sectional view of a composite wrap material according to the invention.

FIG. 5 is a cross-sectional view of a composite wrap material according to the invention.

FIG. 6 is a cross-sectional view of a composite wrap material according to the invention.

FIG. 7 is a cross-sectional view of a composite wrap material according to the invention.

### DETAILED DESCRIPTION OF THE INVENTION

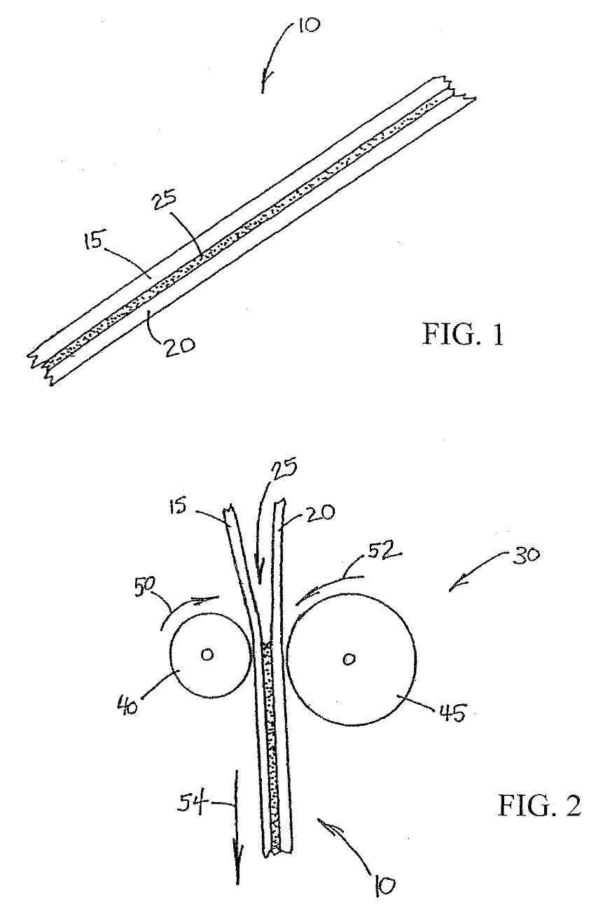

Referring now to the drawings, an embodiment of a composite wrap material of the invention generally designated with the numeral 10, is shown in cross-section in FIG. 1.

The composite wrap material 10 is made of a first layer 15 composed of a cellulosic material, a second layer 20 composed of a polymer-based film material, and an adhesive layer 25 positioned between the first and second layers. The present composite wrap material has an increased strength compared to conventional wrap materials, and is particularly effective in maintaining the integrity of a ream of paper packaged within the wrap material during handling.

The first layer 15 of the wrap material 10 can be any material composed primarily of cellulosic fibers. Suitable materials for use as the first layer 15 include, for example, machine-finished or machine-glazed paper, tissue paper, non-woven tissue paper, air-laid fabric, wet-laid fabric, and wet or dry creped tissue, or other types of paper. An exemplary material for the first layer 15 is a paper having good fold retention with a basis weight of about 5-80 lbs. per 3,000 sq. ft., preferably about 20-60 lbs. per 3,000 sq. ft. The caliper of the first layer 15 is such that the material can be readily run through a conventional wrapping apparatus used to package reams of paper.

The second layer 20 of the composite wrap material 10 is a polymer film material that, when bonded to the first layer 15 will increase the strength of the cellulosic material, and/or provides a high gloss surface over the first layer 15. Such materials include continuous polymer surfaces, for example, films of polyethylene, polypropylene including oriented polypropylene, poly(ethylene terephthalate) such as Mylar polyesters, nylon, ionomer resin such as Surlyn ionomer resins, polyester, and non-continuous, non-woven webs made of fibers composed of those polymer materials.

An adhesive layer 25 is interposed between the first and second layers 15, 20. The adhesive is typically in the form of a liquid or flowable material. Examples of useful adhesives include wax/polymer blends, polyethylene, polypropylene, polyvinylidene chloride, polyethylene acrylic acid, polyester, polyisobutylene, nylon, polymethylpentene, ethylene vinyl acetate, and copolymers thereof. Also useful are hot-melt adhesives, and wax/polymer blends. Such adhesive materials are further described in the Handbook of Adhesives, I. Skeist (ed.), 2d edition, Van Nostrand Reinhold Company, New York (1977), and Adhesives Handbook, J. Shields, Newnes-Butterworths, London (1976).

The polymer-based film second layer 20, and/or the adhesive layer 25, alone or in combination, form a moisture vapor barrier to inhibit the absorption of moisture by the paper or other material contained inside the wrapper. This helps protect a paper product from curling or warping.

Optionally, one or more of the three layers 15, 20, 25, of the composite wrap material can include a coloring agent to provide a transparent, or an opaque colored wrap material to mask the product contained within. Examples of coloring agents that will impart a transparent coloring effect include organic pigments such as a monazo pigment (Lake Red C, Nickel Azo Yellow), a diazo pigment (Benzidine Yellow), phthalocyanine pigments, and fluorescent pigments, among others. Coloring agents that will impart opacity include, for example, inorganic pigments such as titanium dioxide or barium sulfate (white), a metallic oxide pigment such as an iron oxide, zinc oxide or chromium oxide greens, ultramarine pigments, cadmium pigments, and pearlescent pigments, among others. A thin layer of metal can also be used as a pigment coating.

In use, one side of the wrap material is placed next to the paper or other material being wrapped. The other side of the wrap material may be printed upon using known printing techniques, or the paper layer 15 or film layer 20 can be printed before lamination, and then laminated so the print shows through the film layer.

The densities of the paper layer 15 and the polymer film layer 20 of the composite wrap material 10 can be varied to control the performance of the final structure on the packaging equipment.

The composite wrap material 10 can be prepared, for example, by extrusion lamination as schematically depicted in FIG. 2. The laminating device 30 includes two nip rollers 40, 45 that rotate in opposite directions, as shown by arrows 50, 52. Prior to passing through the nip rollers 40, 45, the paper layer 15 and film layer 20 are directed into an adjacent, non-contact position using known techniques. The adhesive material 25 is applied to the paper layer 15 and/or the film layer 20 in close proximity to the nip rollers. Preferably, the adhesive material 25 initially contacts one of the layers 15, 20 prior to passing into the nip rollers. As the layers 15, 20, 25, pass through the nip rollers 40, 45 in the direction of arrow 54, the three layers contact for the first time to form a three-layered wrap material 10. Preferably, the composite wrap material 10 is prepared such that the first and second layers 15, 25 are continuously bonded together with substantially no air pockets thereinbetween. Substantially no air pockets means, approximately less than three air pockets of about 1 mm in diameter formed between the substrate and laminate in ten square feet of material.

The temperature of the rollers 40, 45 can be varied according to the processing temperature of the adhesive material and the processing contact time. One or both of the rollers 40, 45 can be maintained at a temperature to cool and set the adhesive 25 as required. In a typical set-up, the surface temperature of the roller 45 is controlled for cooling the adhesive. In passing the two sheets 15, 20, and adhesive layer 25 through the laminating device 30, either the paper layer 15 or the film 20 can be placed in direct contact with the chilled roller.

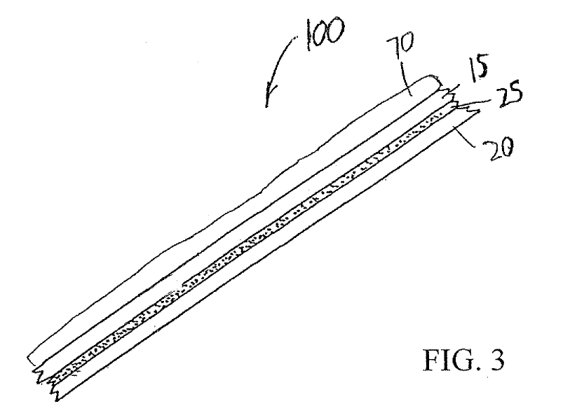

FIG. 3 shows a composite wrap material 100 that is made of a first layer 15 composed of a cellulosic material, a second layer 20 composed of a polymer-based film material, and an adhesive layer 25 positioned between the first and second layers. In addition poly coat 70 is added on the paper layer 15. This additional layer of poly 70 is either made of polyethylene or polypropylene. This allows the inner layer of poly/adhesive 25, to bond to the outer layer of film 20 through heat. This eliminates the need for gluing the product. There may also be added additional coatings or treatments or other layers that may be put on the outside of the film to get the heat seal.

In one embodiment, the ream wrap of FIG. 3 is produced by coating the paper 15 with a layer of poly 70. Prior to passing through the nip rollers 40, 45, the paper layer 15 coated with a layer of poly 70 and film layer 20 are directed into an adjacent, non-contact position using known techniques. The adhesive material 25 is applied to the paper layer 15 on the side of the paper not having the poly coating 70 and/or the film layer 20 in close proximity to the nip rollers. Preferably, the adhesive material 25 initially contacts one of the layers 15, 20 prior to passing into the nip rollers. As the layers 15, 20, 25, and 70, pass through the nip rollers 40, 45 in the direction of arrow 54, a four-layered wrap material 100 is formed. Preferably, the composite wrap material 100 is prepared such that the layers 15, 20 are continuously bonded together with substantially no air pockets thereinbetween. Layer 70 can include a coloring agent to provide a transparent, or an opaque colored wrap material to mask the product contained within.

In a further embodiment, the ream wrap of FIG. 3 is produced by passing through the nip rollers 40, 45, the paper layer 15 and film layer 20 directed into an adjacent, non-contact position using known techniques. The adhesive material 25 is applied to the paper layer 15 and/or the film layer 20 in close proximity to the nip rollers. Preferably, the adhesive material 25 initially contacts one of the layers 15, 20 prior to passing into the nip rollers. The layers 15, 20, and 25 pass through the nip rollers 40, 45 in the direction of arrow 54 forming a three layered wrap material, A poly layer 70 is added to the paper layer 15 to produce a four layered ream wrap 100. Preferably, the composite wrap material 100 is prepared such that the layers 15, 20 are continuously bonded together with substantially no air pockets thereinbetween. Layer 70 can include a coloring agent to provide a transparent, or an opaque colored wrap material to mask the product contained within.

The composite wrap material 10 is made of a first layer 15 composed of a cellulosic material, a second layer 20 composed of a polymer-based film material, and an adhesive layer 25 positioned between the first and second layers. The present composite wrap material has an increased strength compared to conventional wrap materials, and is particularly effective in maintaining the integrity of a ream of paper packaged within the wrap material during handling.

The first layer 15 of the wrap material 10 can be any material composed primarily of cellulosic fibers. Suitable materials for use as the first layer 15 include, for example, machine-finished or machine-glazed paper, tissue paper, non-woven tissue paper, air-laid fabric, wet-laid fabric, and wet or dry creped tissue, or other types of paper. An exemplary material for the first layer 15 is a paper having good fold retention with a basis weight of about 5-80 lbs. per 3,000 sq. ft., preferably about 20-60 lbs, per 3,000 sq. ft. The caliper of the first layer 15 is such that the material can be readily run through a conventional wrapping apparatus used to package reams of paper.

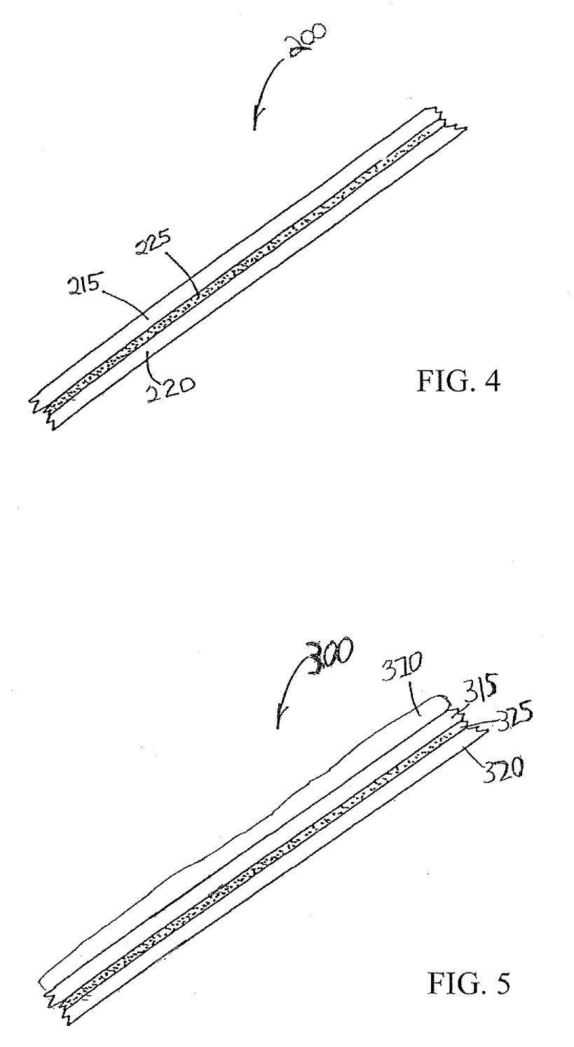

FIG. 4 relates to a composite wrap material 200 made of a first layer 215 composed of a cellulosic material, a second layer 220 comprising a heat seal layer, and a poly layer 225 positioned between the first and second layers. The present composite wrap material has an increased strength compared to conventional wrap materials, and is particularly effective in maintaining the integrity of a ream of paper packaged within the wrap material during handling.

The first layer 215 of the wrap material 200 can be any material composed primarily of cellulosic fibers. Suitable materials for use as the first layer 215 include, for example, machine-finished or machine-glazed paper, tissue paper, non-woven tissue paper, air-laid fabric, wet-laid fabric, and wet or dry creped tissue, or other types of paper. An exemplary material for the first layer 215 is a paper having good fold retention with a basis weight of about 5-80 lbs. per 3,000 sq. ft., preferably about 20-60 lbs. per 3,000 sq. ft. The caliper of the first layer 215 is such that the material can be readily run through a conventional wrapping apparatus used to package reams of paper. Heat seal layer 220 comprises an ethylene based coating.

Optionally, one or more of the three layers 215, 220, 225, of the composite wrap material can include a coloring agent to provide a transparent, or an opaque colored wrap material to mask the product contained within. Examples of coloring agents that will impart a transparent coloring effect include organic pigments such as a monazo pigment (Lake Red C, Nickel Azo Yellow), a diazo pigment (Benzidine Yellow), phthalocyanine pigments, and fluorescent pigments, among others. Coloring agents that will impart opacity include, for example, inorganic pigments such as titanium dioxide or barium sulfate (white), a metallic oxide pigment such as an iron oxide, zinc oxide or chromium oxide greens, ultramarine pigments, cadmium pigments, and pearlescent pigments, among others. A thin layer of metal can also be used as a pigment coating.

FIG. 5 relates to a composite wrap material 300 made of a first layer 310 composed of a cellulosic material, a second layer 315 comprising a poly layer, a third layer 325 comprising a primer layer and a fourth layer 320 comprising a heat seal layer. The present composite wrap material has an increased strength compared to conventional wrap materials, and is particularly effective in maintaining the integrity of a ream of paper packaged within the wrap material during handling.

The first layer 310 of the wrap material 300 can be any material composed primarily of cellulosic fibers. Suitable materials for use as the first layer 310 include, for example, machine-finished or machine-glazed paper, tissue paper, non-woven tissue paper, air-laid fabric, wet-laid fabric, and wet or dry creped tissue, or other types of paper. An exemplary material for the first layer 310 is a paper having good fold retention with a basis weight of about 5-80 lbs. per 3,000 sq. ft., preferably about 20-60 lbs. per 3,000 sq. ft. The caliper of the first layer 310 is such that the material can be readily run through a conventional wrapping apparatus used to package reams of paper. The primer layer comprises chemicals which promote the heat seal layer to adhere. The heat seal layer comprises an ethylene based coating.

Optionally, one or more of the layers 310, 315, 320, and 325, of the composite wrap material can include a coloring agent to provide a transparent, or an opaque colored wrap material to mask the product contained within. Examples of coloring agents that will impart a transparent coloring effect include organic pigments such as a monazo pigment (Lake Red C, Nickel Azo Yellow), a diazo pigment (Benzidine Yellow), phthalocyanine pigments, and fluorescent pigments, among others. Coloring agents that will impart opacity include, for example, inorganic pigments such as titanium dioxide or barium sulfate (white), a metallic oxide pigment such as an iron oxide, zinc oxide or chromium oxide greens, ultramarine pigments, cadmium pigments, and pearlescent pigments, among others. A thin layer of metal can also be used as a pigment coating.

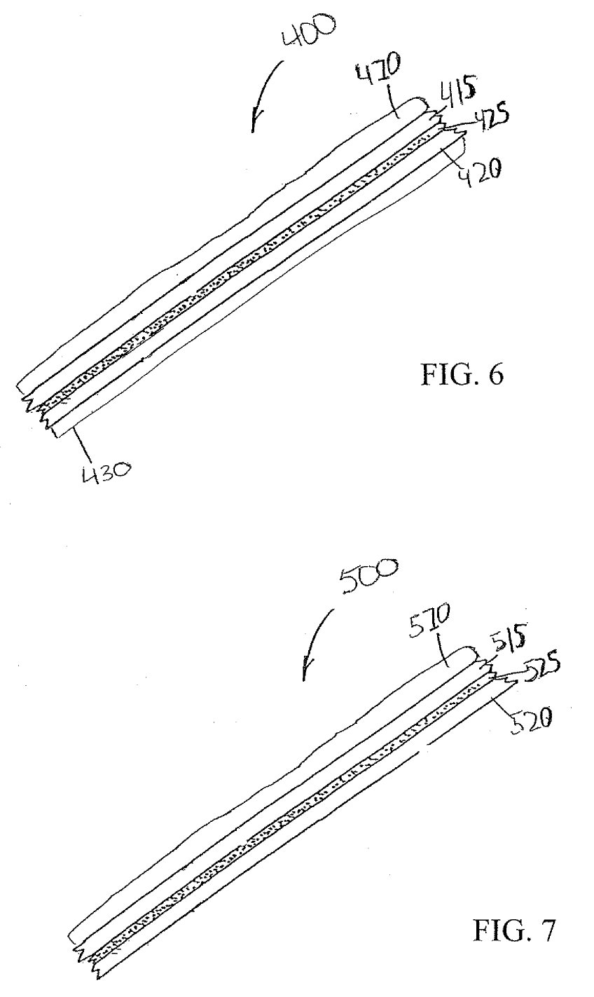

FIG. 6 shows a composite wrap material 400 made of a first layer 410 composed of a cellulosic material, a second layer 425 composed of a polymer-based film material, an adhesive or poly layer 415 positioned between the first and second layers. A layer of primer 420 is on top of the film layer. And a heat seal layer 430 is on top of the primer layer. The present composite wrap material has an increased strength compared to conventional wrap materials, and is particularly effective in maintaining the integrity of a ream of paper packaged within the wrap material during handling.

The first layer 410 of the wrap material 400 can be any material composed primarily of cellulosic fibers. Suitable materials for use as the first layer 410 include, for example, machine-finished or machine-glazed paper, tissue paper, non-woven tissue paper, air-laid fabric, wet-laid fabric, and wet or dry creped tissue, or other types of paper. An exemplary material for the first layer 410 is a paper having good fold retention with a basis weight of about 5-80 lbs. per 3,000 sq. ft., preferably about 20-60 lbs. per 3,000 sq. ft. The caliper of the first layer 410 is such that the material can be readily run through a conventional wrapping apparatus used to package reams of paper.

The second layer 425 of the composite wrap material 400 is a polymer film material that, when bonded to the first layer 410 will increase the strength of the cellulosic material, and/or provides a high gloss surface over the first layer 410. Such materials include continuous polymer surfaces, for example, films of polyethylene, polypropylene including oriented polypropylene, poly(ethylene terephthalate) such as Mylar polyesters, nylon, ionomer resin such as Surlyn ionomer resins, polyester, and non-continuous, non-woven webs made of fibers composed of those polymer materials.

An adhesive or poly layer 415 is interposed between the first and second layers 410 and 425. The adhesive is typically in the form of a liquid or flowable material. Examples of useful adhesives include wax/polymer blends, polyethylene, polypropylene, polyvinylidene chloride, polyethylene acrylic acid, polyester, polyisobutylene, nylon, polymethylpentene, ethylene vinyl acetate, and copolymers thereof. Also useful are hot-melt adhesives, and wax/polymer blends. Such adhesive materials are further described in the Handbook of Adhesives, I. Skeist (ed.), 2d edition, Van Nostrand Reinhold Company, New York (1977), and Adhesives Handbook, J. Shields, Newnes-Butterworths, London (1976).

The polymer-based film second layer 425, and/or the adhesive or poly layer 415, alone or in combination, form a moisture vapor barrier to inhibit the absorption of moisture by the paper or other material contained inside the wrapper. This helps protect a paper product from curling or warping. The primer layer comprises chemicals which promote the heat seal layer to adhere. The heat seal layer comprises an ethylene based coating.

Optionally, one or more of the layers 410, 415, 420, 425, and 430 of the composite wrap material can include a coloring agent to provide a transparent, or an opaque colored wrap material to mask the product contained within. Examples of coloring agents that will impart a transparent coloring effect include organic pigments such as a monazo pigment (Lake Red C, Nickel Azo Yellow), a diazo pigment (Benzidine Yellow), phthalocyanine pigments, and fluorescent pigments, among others. Coloring agents that will impart opacity include, for example, inorganic pigments such as titanium dioxide or barium sulfate (white), a metallic oxide pigment such as an iron oxide, zinc oxide or chromium oxide greens, ultramarine pigments, cadmium pigments, and pearlescent pigments, among others. A thin layer of metal can also be used as a pigment coating.

In use, one side of the wrap material is placed next to the paper or other material being wrapped. The other side of the wrap material may be printed upon using known printing techniques, or the paper layer 410 or film layer 425 can be printed before lamination, and then laminated so the print shows through the film layer.

The densities of the paper layer 410 and the polymer film layer 425 of the composite wrap material 400 can be varied to control the performance of the final structure on the packaging equipment.

FIG. 7 shows a composite wrap material 500 made of a first layer 510 composed of a cellulosic material, a second layer 525 composed of a polymer-based film material, an adhesive or poly layer 515 positioned between the first and second layers. A heat seal layer 520 is on top of the film layer. The present composite wrap material has an increased strength compared to conventional wrap materials, and is particularly effective in maintaining the integrity of a ream of paper packaged within the wrap material during handling.

The first layer 510 of the wrap material 500 can be any material composed primarily of cellulosic fibers. Suitable materials for use as the first layer 510 include, for example, machine-finished or machine-glazed paper, tissue paper, non-woven tissue paper, air-laid fabric, wet-laid fabric, and wet or dry creped tissue, or other types of paper. An exemplary material for the first layer 510 is a paper having good fold retention with a basis weight of about 5-80 lbs. per 3,000 sq. ft., preferably about 20-60 lbs. per 3,000 sq. ft. The caliper of the first layer 510 is such that the material can be readily run through a conventional wrapping apparatus used to package reams of paper.

The second layer 525 of the composite wrap material 500 is a polymer film material that, when bonded to the first layer 510 will increase the strength of the cellulosic material, and/or provides a high gloss surface over the first layer 510. Such materials include continuous polymer surfaces, for example, films of polyethylene, polypropylene including oriented polypropylene, poly(ethylene terephthalate) such as Mylar polyesters, nylon, ionomer resin such as Surlyn ionomer resins, polyester, and non-continuous, non-woven webs made of fibers composed of those polymer materials.

An adhesive or poly layer 515 is interposed between the first and second layers 510 and 525. The adhesive is typically in the form of a liquid or flowable material. Examples of useful adhesives include wax/polymer blends, polyethylene, polypropylene, polyvinylidene chloride, polyethylene acrylic acid, polyester, polyisobutylene, nylon, polymethylpentene, ethylene vinyl acetate, and copolymers thereof. Also useful are hot-melt adhesives, and wax/polymer blends. Such adhesive materials are further described in the Handbook of Adhesives, I. Skeist (ed.), 2d edition, Van Nostrand Reinhold Company, New York (1977), and Adhesives Handbook, J. Shields, Newnes-Butterworths, London (1976).

The polymer-based film second layer 525, and/or the adhesive or poly layer 515, alone or in combination, form a moisture vapor barrier to inhibit the absorption of moisture by the paper or other material contained inside the wrapper. This helps protect a paper product from curling or warping. The heat seal layer comprises an ethylene based coating.

Optionally, one or more of the layers 510, 515, 520, and 525 of the composite wrap material can include a coloring agent to provide a transparent, or an opaque colored wrap material to mask the product contained within. Examples of coloring agents that will impart a transparent coloring effect include organic pigments such as a monazo pigment (Lake Red C, Nickel Azo Yellow), a diazo pigment (Benzidine Yellow), phthalocyanine pigments, and fluorescent pigments, among others. Coloring agents that will impart opacity include, for example, inorganic pigments such as titanium dioxide or barium sulfate (white), a metallic oxide pigment such as an iron oxide, zinc oxide or chromium oxide greens, ultramarine pigments, cadmium pigments, and pearlescent pigments, among others. A thin layer of metal can also be used as a pigment coating.

In use, one side of the wrap material is placed next to the paper or other material being wrapped. The other side of the wrap material may be printed upon using known printing techniques, or the paper layer 510 or film layer 525 can be printed before lamination, and then laminated so the print shows through the film layer.

The densities of the paper layer 510 and the polymer film layer 525 of the composite wrap material 500 can be varied to control the performance of the final structure on the packaging equipment.

The invention has been described by reference to detailed examples and methodologies. These examples are not meant to limit the scope of the invention. Variations within the concepts of the invention are apparent to those skilled in the art. The disclosures of the cited references throughout the application are incorporated by reference herein.

1. A method for producing a composite wrap material, comprising:
placing a paper layer and a film layer into an adjacent, non-contact position;
applying an adhesive material to said paper layer or said film layer;
moving said layers through nip rollers to form a composite wrap material;
placing said composite wrap material on a press; and
applying a primer and heat seal coating.

2. A method for producing a composite wrap material, comprising:
placing a paper layer and a film layer into an adjacent, non-contact position;
applying an adhesive material to said paper layer or said film layer;
passing said paper layer, film layer and said adhesive material through nip rollers;
forming a composite wrap material;
placing said composite wrap material on a press; and
applying a primer and heat seal coating.
